(19) United States
(12) Patent Application Publication
(10) Pub. No.: US 2011/0169341 A1
(43) Pub. Date: Jul. 14, 2011

(54) POWER SAVING CIRCUIT

(76) Inventor: John Manning, Norfolk (GB)

(21) Appl. No.: 12/594,501

(22) PCT Filed: Apr. 2, 2008
(86) PCT No.: PCT/GB08/01158

§ 371 Date: Jul. 15, 2010

(30) Foreign Application Priority Data
Apr. 2, 2007 (GB) 0706401.7

(51) Int. Cl. H01H 47/00

(52) U.S. Cl. 307/126

(57) ABSTRACT

A power saving circuit is provided for a consumer device for disconnecting a mains power supply (2) from a supply circuit (including a transformer (18)) of the device when the device goes into a standby mode. The circuit comprises a high voltage switching module (16) interposed between the mains alternating current electrical power supply (2) and such a supply circuit. The circuit is reset by an actuable initiating component (12, 28) for generating a temporary signal to the high voltage switching module (16) to change the state of the switching module (16) to a conducting state. Then a sensing component (26) operates in a first mode responsive to the supply of mains alternating current to the supply circuit for maintaining the switching module (16) in a conducting state replacing the temporary signal. The sensing component (26) also operates in a second mode responsive to a target condition in the supply circuit indicative of the standby mode for changing the state of the high voltage switching module (16) to a non-conducting state.

The present invention relates to a power saving circuit in particular for use with a charging circuit or with a circuit board of an electrical or electronic device having a standby mode.

There are many electrical devices, some of which are portable, which require a portable direct current power source. This need is generally met by rechargeable batteries or power packs. These have to be charged before use and recharged for further use and a charging circuit is generally used for this purpose. The charging circuit is generally connected to a higher voltage alternating current (AC) mains power supply and transforms the AC mains power and then rectifies it to provide a direct current (DC) compatible with the batteries' or power pack's charging needs. Currently known charging circuits either continue to overcharge past an optimal point or go into a standby mode at the end of the charging process. In addition, the high voltage circuit components of the known charging circuits remain live whenever they are connected to the mains power supply and continue to draw current from the mains supply, at rates up to 40% of their normal operating load.

There are also many mains powered electrical and electronic devices which have a standby mode and this also leads to electricity being drawn form the mains power supply unnecessarily into live high voltage circuit board components.

The proliferation of charging devices and electrical and electronic devices having a standby mode leads to a considerable waste of electricity, which is a disadvantage in terms of the environment and in terms of the cost of the wasted electricity.

According to the present invention, there is provided a power saving circuit for a consumer device for disconnecting a mains alternating current power supply from a supply circuit of the device when the device goes into a standby mode, comprising: a high voltage switching module interposed between such a mains alternating current electrical power supply and such a supply circuit; an initiating component for generating a temporary signal to the switching module to change the state of the switching module to a conducting state; and a sensing component: responsive to the supply of mains alternating current to such a supply circuit for maintaining the switching module in a conducting state replacing the temporary signal; and responsive to a target condition in such a supply circuit indicative of the standby mode for changing the state of the switching module to a non-conducting state.

Where the device is a battery charger and the target condition is a predetermined charge on the batteries, the power saving circuit according to the present invention provides a saving of electrical power, an improvement in the service life of rechargeable batteries, as they are not overcharged and in improved safety as high and low voltage components of the battery charger are not supplied with mains electricity once charging is complete. When the device is an electrical device and the target condition is a standby mode, such as an idle mode or redundant mode, the present invention provides a saving of electrical power and again improved safety.

When the consumer device of the present invention is not in use, the present invention isolates the mains supply to the supply circuit of the consumer device, which supply circuit may include a transformer and so reduces power consumption leading to economic benefits to users and environmental benefits, including reduced carbon emissions, without requiring consumers to sacrifice present levels of utility in terms of functionality or abstinence from use.

The power saving circuit according to the present invention may be implemented within a mains plug, a mains socket or in a bespoke transformer plug. Alternatively, the power saving circuit may be housed separately or within a battery charger or an electrical device.

Where the power saving circuit is used in a battery charger, the target condition may be completion of charging, for example, a predetermined charge on one or more of the batteries within such a battery charger.

Where the power saving circuit is used in an electrical device, such as an electrical appliance or an electronic device having a standby mode, the target condition may be a switching of a supply circuit of such a device into a standby mode, including an idling or similar redundant mode. In this case the supply circuit may be part of the electrical device.

Additional target conditions in which termination of the mains supply to consumer devices is desired may be sensed and signalled by the sensing component in order to isolate the consumer device from the mains electricity supply.

The sensing component may be a voltage comparator and the target condition may be a target voltage or current in such a supply circuit. Such a voltage comparator can be used for supplying current to the high voltage switching module, until the target voltage or current threshold has been reached, whereupon the supply of current to the switching module may be terminated so as to change the state of the switching module to the non-conducting state. Alternatively, the sensing component may be an integrated circuit responsive to the target condition in such a supply circuit, for example a voltage or current level in a part of the supply circuit so as to change the state of the switching module to the non-conducting state.

The initiating component may generate a temporary flow of current to the high voltage switching module or, where the high voltage switching module is photo-sensitive, the initiating component may generate a temporary light signal.

The initiating component may comprise a switch between such a supply circuit and the high voltage switching module, which switch is actuable to close temporarily. In this way temporary closure of the switch may cause a temporary current to flow to the high voltage switching module, or a temporary current to flow to activate a light source, so as to change the state of the switching module to a conducting state.

Alternatively, the initiating component may comprise an induction coil for generating the temporary signal in response to a radio frequency signal from a remote source.

The initiating component may be responsive to a start of a flow of mains alternating current. In this case, the initiating component may comprise a capacitor, responsive to the start of the flow for passing a temporary signal to the high voltage switching module during charging of the capacitor. The start of the flow of mains alternating current may occur after activation of a circuit breaker or on connection of the mains supply to the power saving circuit.

The initiating component may comprise a power source. For example, the power source may be a battery or a solar cell and the circuit may additionally comprise a switch connected between the power supply and the high voltage switching module, which switch is actuable to close temporarily. In this case, the switch may be biased to an open position in which the high voltage switching module is isolated from the power supply and may be manually or remotely actuated into a temporarily closed position for connecting the power supply to the high voltage switching module.

The power saving circuit may additionally comprise a light source wherein the high voltage switching mode comprises a photo switching module triggered into its conductive state in response to the light source, for example in response to activation of the light source. In this case, the power saving circuit may comprise an optical isolator comprising the light source and the photo switching module. This has a further advantage of enabling electrical isolation of a manually actuable switch of the initiating component from the high voltage alternating current mains supply, thus enhancing safety. Where the power saving circuit includes such a light source and the high voltage switching module is a photo switching module, the sensing component may be responsive to the supply of mains alternating current to the supply circuit to activate the light source to maintain the photo-switching module in a conducting state. In this case the sensing component may be responsive to the target condition to deactivate the light source to change the state of the photo switching module to a non-conducting state.

Where the power saving circuit includes such a light source and the high voltage switching module is a photo switching module, the initiating component may comprise a power supply, a light source to which the photo-switching module is sensitive and a switch connected between the power supply and the light source which switch is actuable to close temporarily and generate a temporary signal which is a light signal. Alternatively, the temporary light signal may be generated by temporarily exposing the photo switching module to ambient light.

Thus, the present invention when used in combination with a battery charging device or an electrical device provides a means for the device to be switched back on again or reset, for example by re-connecting the device to the mains supply, circuit breaking, by providing a manually or remotely actuable switch or input from sensors or remote signals whether radio frequency or otherwise in order to generate the temporary signal.

The high voltage switching module may comprise a triac. Also, the initiating component may be responsive to a remote signal in order to generate the temporary signal.

The supply circuit will generally comprise a transformer, which when connected to the mains alternating current will consume power even when the consumer device is in a standby mode. This is prevented by the power saving circuit according to the present invention wherein the high voltage switching module may be interposed between the mains supply and the transformer.

The present invention further provides a battery charger comprising a power saving circuit as described above and a supply circuit comprising a transformer, a rectifier and a charging circuit. It also provides an electrical device having a standby mode and comprising a power saving circuit as described above and a supply circuit comprising a transformer, a rectifier and a circuit board for controlling functionality of the device. The present invention further provides a mains plug, a mains socket and a transformer plug each of which comprising a power saving circuit as described above.

The consumer device according to the present invention may be an electrical device which consumes electricity and is plugged into the mains and which is not constantly in use or does not constantly require a supply of mains electricity.

The present invention may be used on many different consumer electrical appliances or load applications having a stand by, live idling or redundant mode of operation, such as is illustrated herein primarily in relation to battery charging devices, for example for a mobile or cellular telephone batteries. Other potential consumer devices include washing machines, remotely actuated devices, such as hi-fi systems, televisions, television signal receiving equipment, recording equipment or computers. Such consumer electrical devices may be provided with an initiating component, as described above, such as a basic circuit breaker or mains power switch at the wall, an integral mains powered trigger or initiation circuit and/or a capacitor. The initiating component may comprise a receiver, decoder and initiation or trigger circuit, for example powered by a separate battery. It may comprise a radio frequency receiver current induction circuit and a remote radio frequency signal means to induce current therein. It may comprise solar powering means, for example to power a receiver to receive a signal from remote signalling means and then switch on to power an initiating circuit for changing the state of the high voltage switching module.

The invention will now be described by way of example only and with reference to the accompanying schematic drawing, wherein:

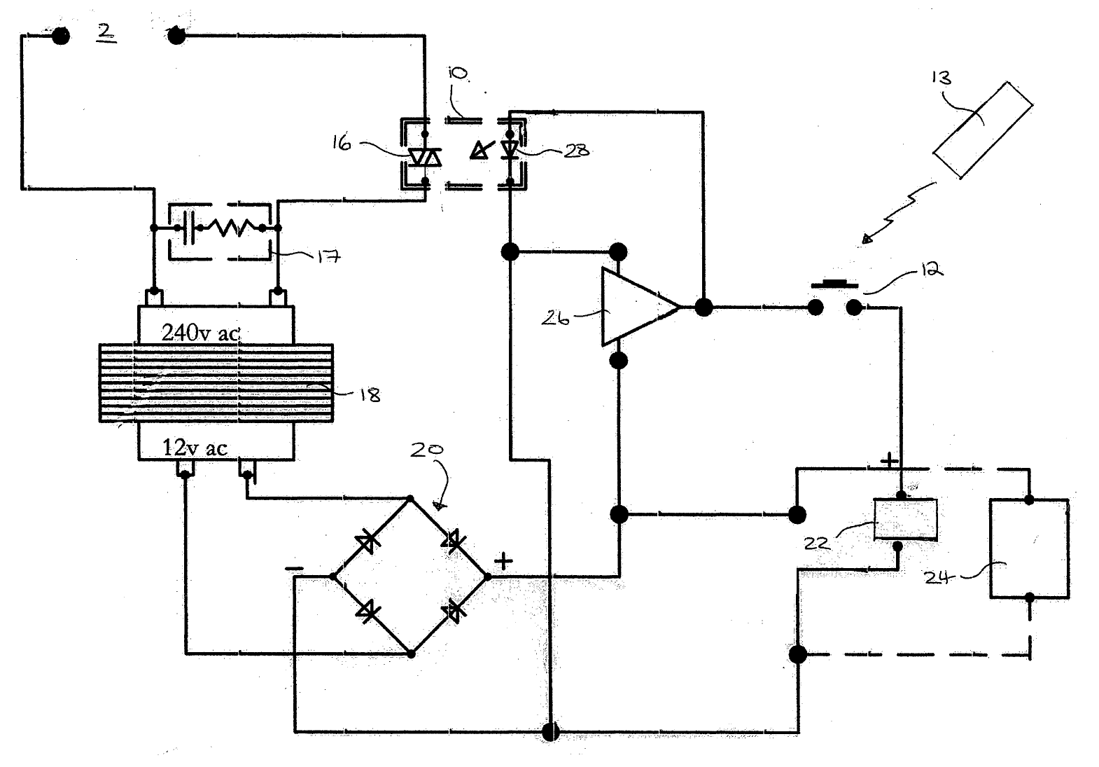

FIG. 1 shows a first power saving circuit according to the present invention;

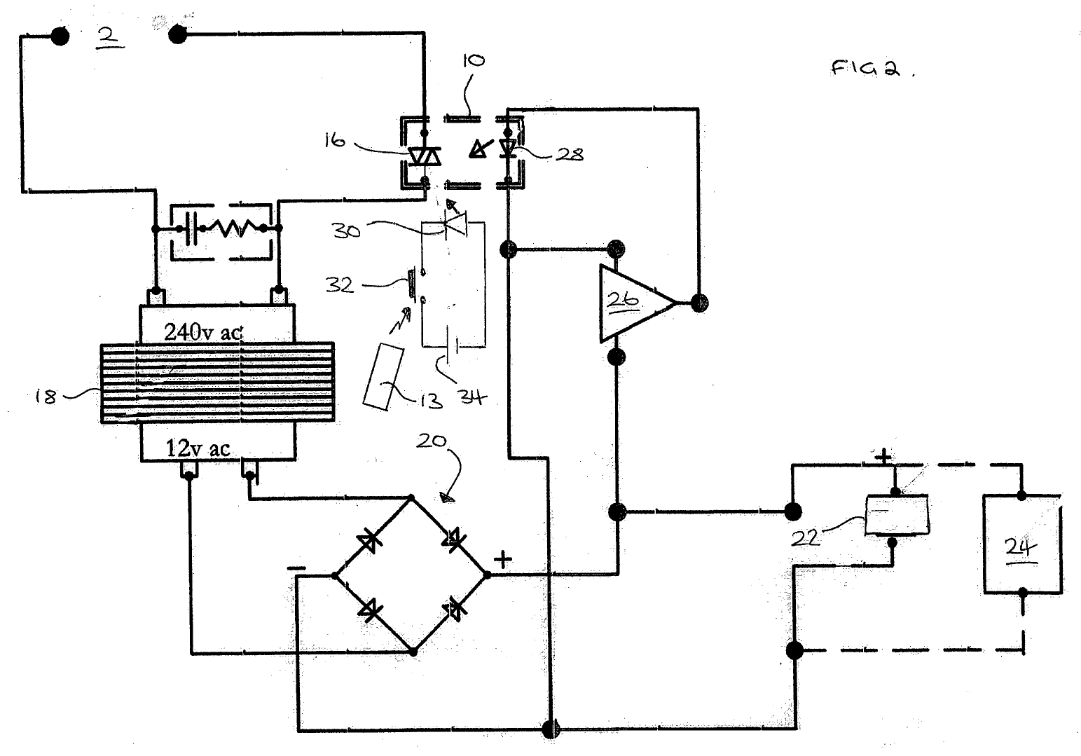

FIG. 2 shows a second power saving circuit according to the present invention;

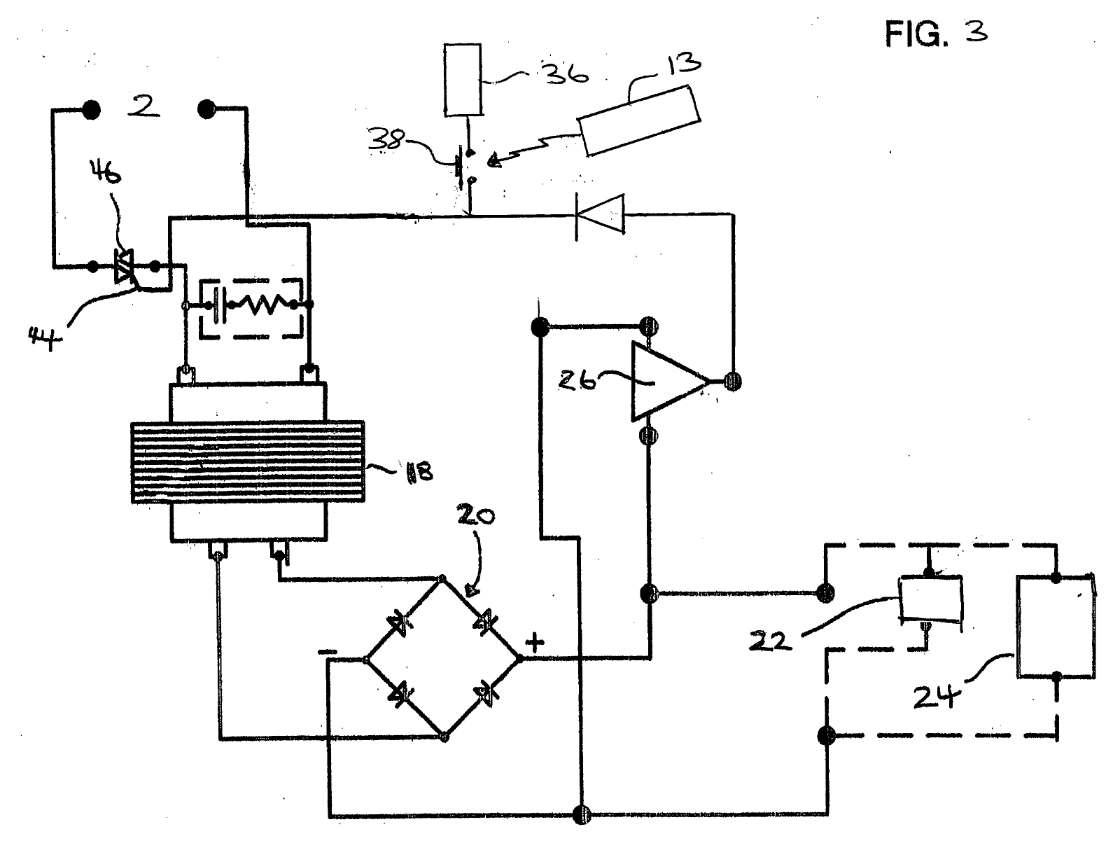

FIG. 3 shows a third power saving circuit according to the present invention;

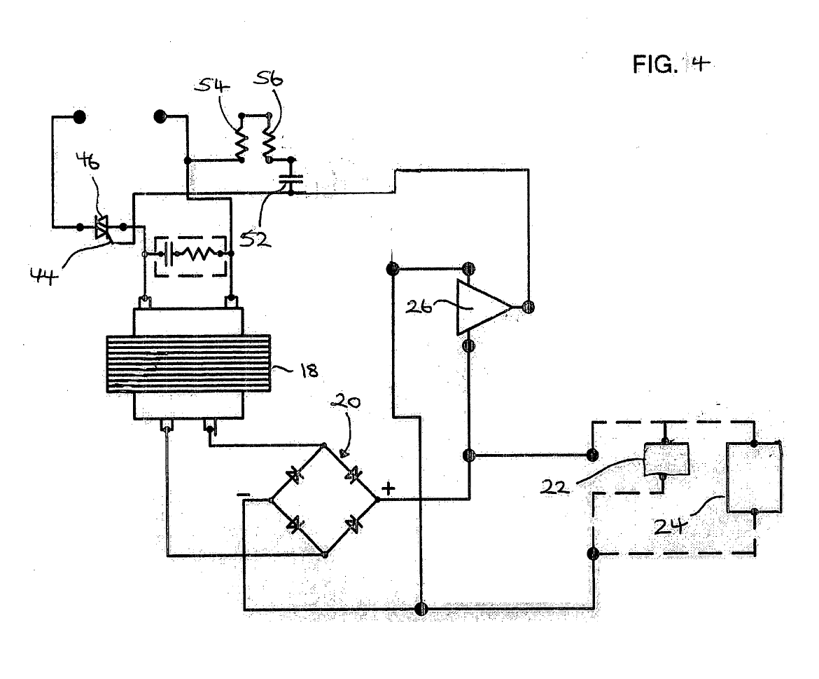

FIG. 4 shows a fourth power saving circuit according to the present invention; and

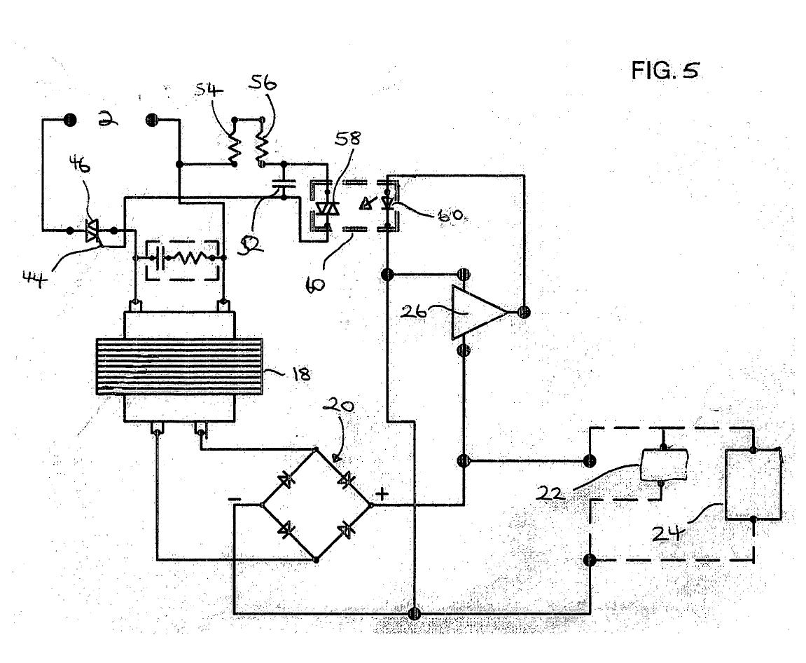

FIG. 5 shows a fifth power saving circuit according to the present invention.

In FIG. 1, the power saving circuit comprises an initiating component comprising a reset switch (12) and a light emitting diode (LED) (28) of an opto-isolator (10). It also comprises a high voltage switching module in the form of a first triac (16) which is also part of the opto-isolator (10) and is responsive to the LED (28). The circuit also comprises a sensing component (26). A supply circuit in FIG. 1 comprising a smoothing circuit (17), a transformer (18), a rectifier (20) and one of a charging circuit (22) of a battery charger and/or a primary circuit board (24) of an electrical device, is also shown in FIG. 1.

The mains alternating current (AC) supply (2) is connected in series with the first triac (16) and the transformer (18), for example by plugging in an electrical plug into a mains socket and switching on the mains socket.

The operation of the supply circuit will begin with the AC supply (2) cut off from the transformer (18), ie. with the first triac (16) in a non-conducting state. In this situation, the supply circuit (22, 24) has previously exhibited a target condition, for example the battery of the charger has become fully charged or the electrical device has moved into in a standby mode. This is sensed by the sensing component (26) which blocks current to the LED (28). With the LED (28) unlit, the first triac (16) is not triggered and so does not pass current, thus isolating the mains supply (2) from the transformer (18).

When it is desired to reactivate the connection between the AC supply (2) and the transformer (18), for example to use the battery charging circuit (22) to charge batteries or to use the electrical device, a user activates the re-set switch (12). The re-set switch is biased, for example mechanically biased to an open position, as shown in FIG. 1. When the re-set switch (12) is activated by a user, for example by depressing the switch, the switch closes temporarily, for example until a user releases the switch. Activation of the re-set switch (12) allows a current to temporarily flow to the LED (28) of the optical isolator (10) to light the LED (28). Where the supply circuit is a battery charging circuit (22), the electrical power to generate the temporary current may come from the batteries within the charging circuit. Even where the battery charge is low, there should be charge enough to generate a small temporary current sufficient to light the LED (28). Alternatively, there should be sufficient charge in the smoothing circuit (17) to generate the required temporary current and this may be relied upon where the supply circuit is a printed circuit board (24) of an electrical device or where there are no batteries within the charging circuit (22). Alternatively, the re-set (12) may be a remotely controlled switch, which may for example be responsive to a remote control unit (13) or other input.

The light from the LED (28) triggers the first triac (16) into its conducting state so that the first triac (16) connects the mains supply (2) to the transformer (18). Thereafter, so long as the LED (28) is lit, the first triac (16) is triggered and passes the AC mains supply (2) to the transformer (18).

The transformer (18) provides an alternating current of the desired (generally lower) voltage to the rectifier (20). The rectifier (20) converts the input alternating current to an output direct current, which direct current is provided to the consumer device which might comprise either:
a charging circuit (22), where the power saving circuit is used in relation to a battery charging device; or
a primary circuit board (24) where the power saving circuit is used in relation to an electrical appliance or electronic device having a standby mode, such as a washing machine or a television.

The connection to the primary circuit board (24) is shown in dotted lines of FIG. 1 to show that it is an alternative to the charging circuit (22).

The current fed to the charging circuit (22) or primary circuit board (24) is monitored by a sensing component (26), which in FIG. 1 is implemented as an integrated circuit component, but could also be implemented as a comparator. While the supply circuit is fed from the rectifier (20), the sensing component (26) provides current to maintain the LED (28) in its lighted state, thus holding the first triac (16) in its triggered state. The power saving circuit of FIG. 1 becomes active very quickly so that the current from the sensing component (26) is present at the LED (28) before the temporary current resulting from activation of the reset switch (12) stops. The supply circuit (22, 24) is now powered and enabled to perform its function.

Once the supply circuit (22, 24) has completed its function a target condition indicating this completion is sensed by the sensing component (26). Where the supply circuit is a charging circuit (22) the target condition may be predetermined voltage achieved within the batteries. Where the consumer device is a primary circuit board (24) the target condition may be when the electrical appliance or electronic device goes into standby mode. In response to the target condition being achieved, the sensing component (26) acts to switch off the current being fed back to the LED (28) of the optical coupler (10). Once the LED (28) is no longer lit, the first triac (16) is no longer triggered and moves into a non-conducting state and so no longer passes current. Therefore the AC mains supply (2) is isolated from the transformer again, as described at the beginning of this description of FIG. 1.

The power supply circuit of FIG. 2 is similar to that of FIG. 1, with like parts shown by like numerals, except that the first triac (16) is not activated by the LED (28) but by instead by an additional light source (30). The additional light source (30) may be a LED powered by a separate power source, for example a battery (34), via a reset-switch (32). Alternatively, the additional light source may be ambient light temporarily exposed to the first triac (16), for example by the temporary opening of a window to the first triac (16).

When it is desired to reactivate the connection between the AC supply (2) and the transformer (18), for example to use the battery charging circuit to charge batteries or to use the electrical device, a user activates the re-set switch (32). The re-set switch is biased, for example mechanically biased to an open position, as shown in FIG. 2. When the re-set switch (32) is activated by a user, for example by depressing the switch, the switch closes temporarily, for example until a user releases the switch. Activation of the re-set switch (32) allows a current to temporarily flow from the power source (34) to the LED light source (30). Alternatively, the re-set switch (32) may be a remotely controlled switch, which may for example be responsive to a remote control unit (13).

The light from the LED (30) (or temporary exposure to ambient light) triggers the first triac (16) to a conducting state so that mains power passes to the transformer (18). The powering of the supply circuit (22, 24) via the transformer (18) and rectifier (20) is sensed by the sensing component (26) which passes a current to the LED (28) to switch on the LED (28) before the temporary light source, for example from the LED (30) is cut off. Thereafter, so long as the LED (28) is lit, the first triac (16) passes the AC mains to the transformer (18).

As described in relation to FIG. 1, in the power saving circuit of FIG. 2, the sensing component (26) is responsive to the target condition in the supply circuit (22, 24) to switch off the LED (28) so as to change the state of the first triac (16) to a non-conducting state so as to isolate the mains supply (2) from the transformer (18).

In FIG. 3, the power saving circuit comprises an initiating component comprising a power source (36) and a reset switch (38). It further comprises a high voltage first triac (46) and a sensing component (26). The supply circuit comprises a transformer (18), a rectifier (20) and one of a charging circuit (22) and a primary circuit board (24).

To initiate the power saving circuit of FIG. 3, the reset switch (38), which may be similar to the reset switches (12, 32) described above in relation to FIGS. 1 and 2, is activated to send a temporary current from the power supply (36) to a gate (44) of the first triac (46). In response to the temporary current, the triac (46) changes to a conducting state to connect the AC mains supply (2) to the transformer (18).

The transformer (18) provides an alternating current of the desired (generally lower) voltage to the rectifier (20). The rectifier converts the input alternating current to an output direct current, which direct current is provided to the charging circuit (22) or printed circuit board (24). The connections to the charging circuit (22) and primary circuit board (24) are shown in dotted lines of FIG. 3 to show that they are alternatives.

The supply circuit is monitored by a sensing component (26), which in FIG. 3 is implemented as an integrated circuit component, but could also be implemented as a comparator. As soon as the mains supply (2) is connected to the supply circuit, this is sensed by the sensing component (26), which in response provides current to the first triac (46) so as to hold the first triac in the conducting state in which it passes AC mains (2) to the transformer (18). This happens quickly enough that the current from the sensing component (26) begins to flow to the first triac before the temporary current is shut off by the opening of the reset switch (38). The consumer device (22, 24) is thus powered and enabled to perform its function.

The sensing component (26), in response to the sensing of the target condition in the supply circuit (22, 24) acts to switch off the current being fed back to the gate (44) of the first triac (46) thereby switching the first triac to its non-conducting state and isolating the AC mains supply (2) from the remainder of the power saving circuit of FIG. 3.

The power supply circuit of FIG. 4 is similar to that described above in relation to FIG. 3, with like parts identified by like numerals, except that the circuit of FIG. 3 is initiated in a different way.

In FIG. 4, the power saving circuit comprises an initiating component comprising resistors (54, 56) and a capacitor (52). In addition it comprises a first triac (46) with a gate (44) and a sensing component (26).

Switching on of an alternating current (AC) mains supply (2) causes current to flow through the pair of resistors (54, 56) and the capacitor (52) through which current flows temporarily onto the gate (44) of the high voltage first triac (46), while the capacitor (12) is charging. The AC supply may be switched on by switching on a mains socket into which an electrical plug powering the circuit of FIG. 4 is fitted. Alternatively, a manually or remotely operated circuit breaking switch can be used to disconnect and then switch on the AC mains supply (2) to charge the capacitor (12), which will have discharged during breaking of the circuit.

The flow of current through the capacitor (12), although of short duration is sufficient for the capacitor to provide a current to the gate (44) of the first triac (46) so that the first triac (46) changes to a conducting state so that mains current passes to the transformer (18). The sensing component (26) senses the activation of the supply circuit and in response feeds a current to the gate (44) of the first triac (46) so as to maintain the first triac in its triggered condition in which is conducts alternating current.

After a short time, of the order of a millisecond, the capacitor (52) becomes fully charged, however, by this time current is supplied to the gate (44) of the first triac (46) by the sensing component (26), thus holding the first triac (16) in its conducting state. The supply circuit (22, 24) is thus powered and enabled to perform its function.

The sensing component (26), is responsive to the target condition in the supply circuit (22, 24) to switch off the current being fed back to the gate (44) of the first triac (46) thereby changing the state of the first triac (46) to a non-conducting state, so isolating the AC mains supply (2) from the supply circuit of FIG. 4.

In FIG. 5, the power saving circuit has like parts labelled with like numerals to FIGS. 3 and 4. The circuit comprises an initiating component comprising resistors (54, 56) and capacitor (12). It also comprises a high voltage first triac (46), a sensing component (26) and an optical isolator (10) which is responsive to the sensing component.

The circuit is initiated in the same way as the circuit of FIG. 4, to trigger the first triac (46) to a conducting state in order to feed the AC mains current (2) to the transformer (18). The current fed to the charging circuit (22) or primary circuit board (24) is monitored by the sensing component (26) and while the mains supply (2) is connected the sensing component (26) supplies current to an LED (60) of the optical isolator (10) to light the LED (60). Lighting of the LED (60) triggers a second triac (58) into a conducting state which feeds current to the gate of the first triac (46) to trigger the first triac into a conductive state so that it continues to connect the mains current (2) to the transformer (18). After a short time, of the order of a millisecond, the capacitor (52) becomes fully charged, however, by this time current is supplied to the gate (44) of the first triac (46) by the second triac (58), thus holding the first triac (16) in its conducting state. The supply circuit (22, 24) is thus powered and enabled to perform its function.

Once the target condition is sensed by the sensing component (26) the sensing component stops the flow of current to the LED (60) of the optical coupler (10) and thereby turns off the second triac (58) which moves to a non-conduction state to stop the flow of current to the gate (44) of the first triac (46). This changes the state of the first triac (46) to a non-conducting state and so blocks the flow of mains current (2) to the transformer (18).

1. A power saving circuit for a consumer device for disconnecting a mains power supply from a supply circuit of the device when the device goes into a standby mode, comprising:
a high voltage switching module interposed between such a mains alternating current electrical power supply and such a supply circuit;
an actuable initiating component for generating a temporary signal to the high voltage switching module to change the state of the switching module to a conducting state; and
a sensing component operable in two mutually exclusive modes:
a first mode responsive to the supply of mains alternating current to such a supply circuit for maintaining the switching module in a conducting state replacing the temporary signal; and
a second mode responsive to a target condition in such a supply circuit indicative of the standby mode for changing the state of the high voltage switching module to a non-conducting state.

2. A circuit according to claim 1 wherein the device is a battery charger wherein the target condition is a predetermined charge on one or more batteries within such a battery charger.

3. A circuit according to claim 1 wherein the device is an electrical device wherein the target condition is a switching of a supply circuit of such a device into a standby mode.

4. A circuit according to claim 1 wherein the sensing component is a voltage comparator and the target condition is a target voltage or current in such a supply circuit.

5. A circuit according to claim 1 wherein the sensing component is an integrated circuit responsive to the target condition in such a supply circuit.

6. A circuit according to claim 1 wherein the initiating component generates a temporary flow of current to the high voltage switching module.

7. A circuit according to claim 1 wherein the initiating component generates a temporary light signal.

8. A circuit according to claim 1 wherein the initiating component comprises a switch between such a supply circuit and the switching module, which switch is actuable to close temporarily.

9. A circuit according to claim 6 wherein the initiating component comprises a capacitor, responsive to a start up flow of mains alternating current for passing the temporary signal to the high voltage switching module during charging of the capacitor.

10. A circuit according to claim 1 wherein the initiating component comprises a power source.

11. A circuit according to claim 10 wherein the initiating component additionally comprises a switch connected between the power source and the high voltage switching module, wherein the switch is actuable to close temporarily.

12. A circuit according to claim 1 additionally comprising a light source wherein the high voltage switching module comprises a photo-switching module triggered into its conducting state by activation of the light source.

13. A circuit according to claim 12 wherein the photo-switching module and light source are part of an optical isolator.

14. A circuit according to claim 12 wherein the sensing component is responsive to the supply of mains alternating current to such a supply circuit for activating the light source replacing the temporary signal to maintain the photo-switching module in a conducting state.

15. A circuit according to claim 12 wherein the sensing component is responsive to the target condition for de-activating the light source to change the state of the photo-switching module to a non-conducting state.

16. A circuit according to claim 12 wherein the initiating component additionally comprises: a power supply; a light source to which the photo-switching module is responsive; and a switch connected between the power supply and the light source and actuable to close temporarily.

17. A circuit according to claim 1 wherein the high voltage switching module comprises a triac.

18. A circuit according to claim 1 wherein the initiating component is responsive to a remote signal to generate the temporary signal.

19. A circuit according to claim 1 in combination with a supply circuit comprising a transformer wherein the high voltage switching module is interposed between the mains supply and the transformer.

20. A battery charger comprising an alternating current input for receiving a mains alternating current electrical power supply, a supply circuit, and a power saving circuit which comprises:
a high voltage switching module interposed between the alternating current input and the supply circuit;
an actuable initiating component for generating a temporary signal to the high voltage switching module to change the state of the switching module to a conducting state; and
a sensing component operable in two mutually exclusive modes:
a first mode responsive to the supply of mains alternating current to the supply circuit for maintaining the switching module in a conducting state replacing the temporary signal; and
a second mode responsive to a target condition in the supply circuit indicative of the standby mode for changing the state of the high voltage switching module to a non-conducting state; and
wherein the supply circuit comprises a transformer, a rectifier and a charging circuit.

21. An electrical device having an alternating current input for receiving a mains alternating current electrical power supply, a supply circuit, a standby mode and a power saving circuit which comprises:
a high voltage switching module interposed between the alternating current input and the supply circuit;
an actuable initiating component for generating a temporary signal to the high voltage switching module to change the state of the switching module to a conducting state; and
a sensing component operable in two mutually exclusive modes:
a first mode responsive to the supply of mains alternating current to the supply circuit for maintaining the switching module in a conducting state replacing the temporary signal; and
a second mode responsive to a target condition in the supply circuit indicative of the standby mode for changing the state of the high voltage switching module to a non-conducting state; and
wherein the supply circuit comprises a transformer, a rectifier and a circuit board for controlling functionality of the device.

22. An electrical plug for connection to a mains alternating current supply for supplying mains alternating current to a supply circuit of a consumer device, which electrical plug comprises a power saving circuit comprising:
a high voltage switching module;
an actuable initiating component for generating a temporary signal to the high voltage switching module to change the state of the switching module to a conducting state; and
a sensing component operable in two mutually exclusive modes:
a first mode responsive to the supply of mains alternating current to such a supply circuit for maintaining the switching module in a conducting state replacing the temporary signal; and
a second mode responsive to a target condition in such a supply circuit indicative of the standby mode for changing the state of the high voltage switching module to a non-conducting state.
